(19) United States
(12) Patent Application Publication
(10) Pub. No.: US 2008/0054805 A1
(43) Pub. Date: Mar. 6, 2008

(54) Gas Discharge Lamp and Socket

(75) Inventor: Frank Gerardus Cornelis De Bot, Roosendaal (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,977

(22) PCT Filed: May 26, 2005
(86) PCT No.: PCT/IB05/51729

§ 371 Date: Dec. 4, 2006

(30) Foreign Application Priority Data
Jun. 8, 2004 (EP) 04102574.3

(51) Int. Cl. H01J 61/04

(52) U.S. Cl. 313/567

(57) ABSTRACT

A gas discharge lamp comprising a tubular discharge vessel having two end portions, wherein in each end portion an electrode is arranged for generating and maintaining a discharge in the discharge vessel, said lamp having two short substantially tubular end caps coaxially extending from both ends of the discharge vessel, wherein each electrode is connected with at least two external metal contact members arranged on one of said end caps for connecting the lamp with a power supply, each of said contact members comprising an at least partially substantially circular contact surface, and wherein the at least partially substantially circular contact surfaces are arranged coaxially with said substantially tubular end cap and are mutually axially spaced apart.

A gas discharge lamp comprising a tubular discharge vessel having two end portions, wherein in each end portion an electrode is arranged for generating and maintaining a discharge in the discharge vessel, said lamp having two short substantially tubular end caps coaxially extending from both ends of the discharge vessel, wherein each electrode is connected with at least two external metal contact members arranged on one of said end caps for connecting the lamp with a power supply, each of said contact members comprising an at least partially substantially circular contact surface.

Such a gas discharge lamp is well known, for instance the standard low-pressure linear fluorescent lamps with a bi-pin cap, such as the Philips TL lamp series. The contact members of the known lamp are two parallel metal pins extending in axial direction from the end caps. The two pins can be placed in a slit shaped recess with corresponding contact members of a lamp holder or socket. The lamp can be fixed in the socket by rotating the lamp and the contact members around the lamp axis by 90 degrees.

The known lamps can be difficult to mount in the socket, because two pairs of pins must simultaneously be inserted in a lateral direction of the lamp in two small slits which are located a relative large distance apart, which act can be particularly difficult for the vision impaired and also for most people if the lamp has to be mounted over one's head in a socket under the ceiling of a room. It is therefore, amongst others, a goal of the invention to provide a lamp system that is easier to mount.

To that end the at least partially substantially circular contact surfaces are arranged coaxially with the substantially tubular end cap and are mutually axially spaced apart. Thereby the axial rotation of the lamp does not matter when the lamp is mounted, and also the diameter of the contact member can be much larger than the prior art lamps. One can thus fix the lamp in the socket easily, even without looking at, or touching, the contact members. The latter is also much safer, because the danger of electric shock for the user is thereby diminished.

A further advantage is that the lamp can be rotated to any desired position while it is mounted in the socket. This can be advantageous for certain applications as explained below. A still further advantage is that the end walls of the end caps are free of extensions, and it is thereby for instance possible to apply a heating element against the end wall in a very effective manner and thereby achieve a constant temperature of the end portion of the lamp, irrespective of environmental conditions. A constant temperature is advantageous with respect to the stability of the lamp, because for instance the mercury pressure in the lamp can be controlled effectively if an elongated stem containing an amalgam extends from the discharge vessel into the lamp cap.

A still further advantage is the fact that the space that is needed for mounting the lamp in the axial direction at both sides of the discharge vessel can be smaller than with the prior art lamps having the bi-pin caps. Thereby shadow areas at the sides of the lamp can be prevented, or at least be diminished, or alternatively the mounting space of the lamp can be smaller.

The term “substantially circular” in relation with the contact surfaces of the lamp according to the invention must be understood very broadly. Any polygonal or oval shape can be applied as well, which will accordingly limit the positions in which the lamp can be rotated. For most general purposes a round shape will be the preferred choice.

A single circular contact surface which is coaxially arranged at both ends of a lamp is known, for instance from U.S. Pat. No. 4,979,081.

Multiple circular contact surfaces in electrical appliances which are coaxially arranged and mutually axially displaced as such are known, for instance in a stereo audio plug. However such a plug is not laterally mounted in two spaced apart receiving recesses, but instead the plug is axially inserted in a hole. The problem solved by the current invention and its advantages are therefore not associated with these audio plugs.

Preferably the outer diameters of the two substantially circular contact surfaces are smaller than the outer diameter of the end cap, and the substantially circular contact surfaces of the contact members are preferably located in at least one substantially ring shaped recess in the substantially tubular surface of the end cap. More preferably each of the substantially circular contact surfaces of the contact members is located in a separate substantially ring shaped recess in the substantially tubular surface of the end cap. This has the advantage that fingers cannot touch the electrical contact members because they are wider than the recesses. Also this provides the possibility to use the location and mutual distance between the contact members as a discriminator, determining the lamp type. The lamp can then only be mounted in a socket containing a ballast that is suitable for that lamp type.

Preferably the outer diameters of the substantially circular contact surfaces are substantially equal, and the outer diameter of the end cap is preferably approximately equal to the outer diameter of the discharge vessel. The end cap is preferably made of electrically isolating material.

In a special preferred embodiment the wall of the discharge vessel comprises at least one coating for changing the light transmitting properties of the wall, said coating extending along substantially the entire length and covering only a part of the circumference of the discharge vessel. This feature as such is for instance shown in fluorescent lamps, which have been long established for document copying applications, and which feature a clear stripe through which much of the light exits. The tube is internally coated with an aluminium oxide reflective layer and then the phosphor, and a stripe is wiped clean to form the aperture. This method increases the luminance in the region of the aperture by as much as a factor of five, and makes a highly efficient directional fluorescent lamp. The concept was then further extended to standard fluorescent lamps in order to create a product especially tailored to the requirements the emerging edge-lit sign industry.

Illuminated signs have traditionally been lit from behind with rows of fluorescent lamps, which is inefficient, results in unsightly bands of light, and quite deep signs are required. The signs now feature acrylic sheets bearing micro-replication patterns where light can be injected into the edge of the panel and then uniformly spread out over the whole area. This results in a more efficient, more uniformly lit and much slimmer sign. Originally, these signs were edge-lit around the perimeter with standard fluorescent tubes, but the efficiency with which light was coupled from the tube into the sheet was rather low. The increased intensity along the stripe of the lamp proved a much more efficient solution. The publicly available Philips T5 aperture tubes have a 5 mm wide clear band with a 50-degree beam angle, while the T8 versions have an 8 mm wide band and 30-degree beam angle, and significantly brighter signs can be realised by applying such stripes. By applying lamps with circular contact members as provided by the invention a versatile solution is offered, wherein the lamp can be rotated freely for different light effects according to the needs of the user, in particular when different sheets or light guides are arranged around the lamp.

In a further preferred embodiment each end portion comprises at least two electrodes and at least three contact members with substantially circular contact surfaces. The middle contact members therein are for instance connected to both electrodes. Thereby the life of the lamp can be extended as follows. A first pair of electrodes is used by mounting the corresponding first and second contact members, until they reach their end of life, and then the second pair of electrodes can be used by demounting the lamp and remount it while shifting the lamp in axial direction using the corresponding second and third contact members of the lamp. Alternatively, in a specially adapted socket having three contact members at each end and an end-of-life detection circuit, switching from the first to the second electrode can be achieved automatically.

The invention also relates to a socket for holding and feeding a gas discharge lamp according to any of the previous claims, comprising a housing and two sets of at least two metal socket contact members each for contacting the lamp contact members, said socket contact members comprising at least one strip-shaped contact surface extending tangential to the substantially circular lamp contact surface of the corresponding lamp contact member in the mounted condition. The word “strip-shaped” in this respect comprises any elongated straight or bent shape. The strip-shaped contact member can be for instance resiliently be mounted in said socket, such that contact member of the lamp is clamped thereby. Also other retaining mechanisms are possible. Said strip-shaped contact surface is preferably located on a rib extending from the wall of the housing, which rib extends into the corresponding substantially ring shaped recess in the substantially tubular surface of the end cap in the mounted condition, and each socket contact member preferably comprises two substantially parallel strip-shaped contact surfaces which are spaced apart at a distance corresponding to the outer diameter of the substantially ring shaped lamp contact surfaces in the mounted condition.

The invention will now be illustrated by way of preferred embodiments with reference to the drawings, wherein:

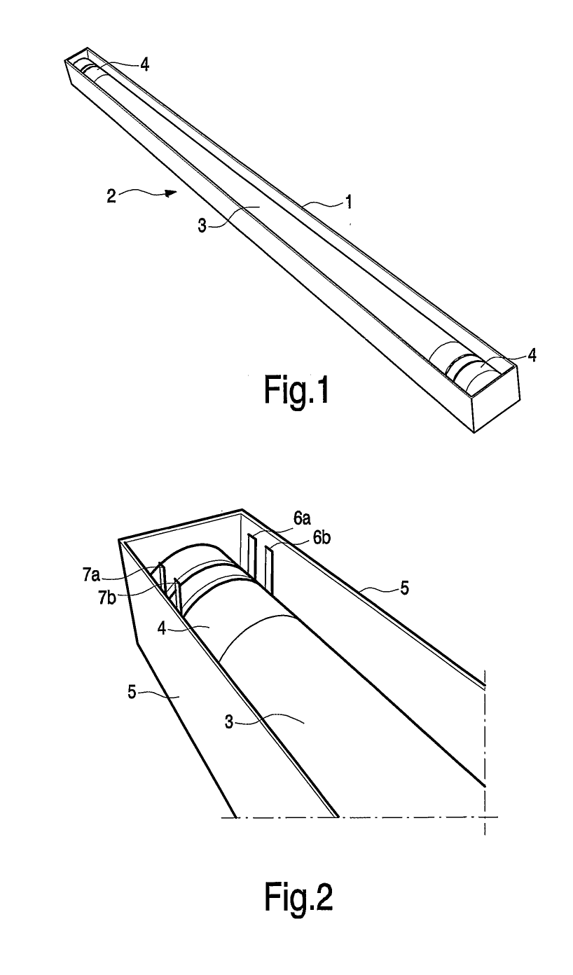

FIG. 1 shows a perspective view of a socket holding a fluorescent low pressure gas discharge lamp;

FIG. 2 shows a perspective view of a detail of the socket and lamp of FIG. 1;

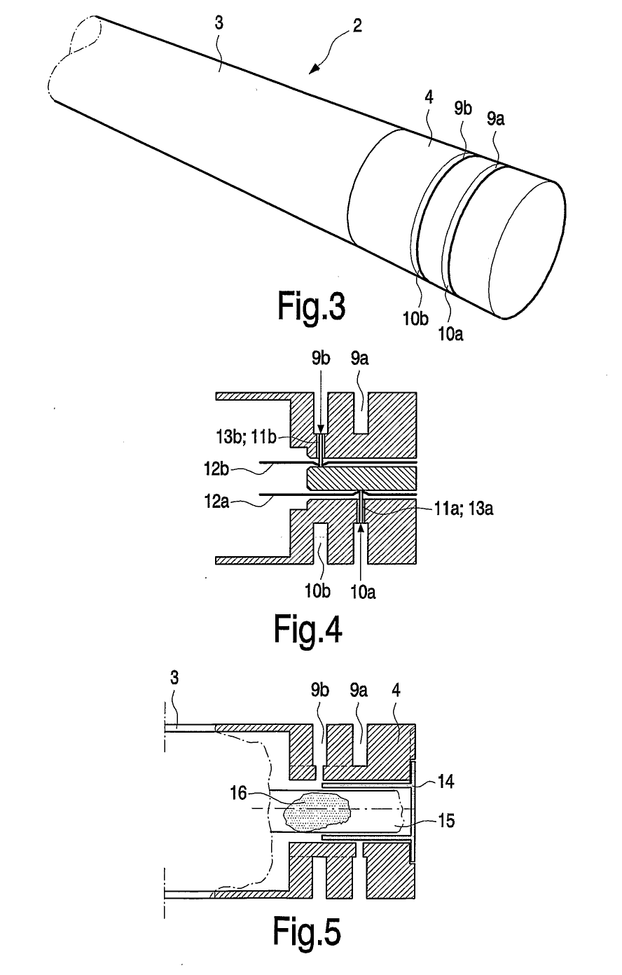

FIG. 3 shows a perspective view of a detail of the lamp of FIG. 1;

FIG. 4 shows a partial schematic sectional view of the lamp cap of a first embodiment of the lamp of FIG. 1; and

FIG. 5 shows a partial schematic sectional view of the end portion of a second embodiment of the lamp of FIG. 1.

Equal reference numerals are assigned throughout the figures with respect to the same features.

According to FIGS. 1 and 2 a socket 1 holds a fluorescent low-pressure gas discharge lamp 2. Fluorescent low-pressure gas discharge lamps are well known in the art and comprise a tubular glass discharge vessel 3, containing a gas filling and two electrodes arranged at both ends of the discharge vessel 3. The lamp according to the figures further comprises a substantially tubular end cap 4 at both ends of the discharge vessel 3, made of a non-conducting plastic or ceramic material, and which are sealed onto said ends by means of glue or cement.

The socket 1 comprises non-conductive walls 5 having two pairs of ribs 6a, 6b at each end. The ribs 6a, 6b are provided with strip-shaped contact members 7a, 7b comprised of a metal (for instance copper) conductive layer, which conductive layer extends perpendicular to the lamp axis. Each pair of contact members 7a, 7b is connected to one of two poles of a ballast (not shown). The distance between the two members of each pair of contact members 7a, 7b is smaller than the outer diameter of the end cap 4. The end caps 4 comprise two ring-shaped grooves 9a, 9b having a width corresponding to the width of the contact members 7a, 7b, such that the contact members 7a, 7b can extend into said grooves 9a, 9b.

According to FIGS. 3 and 4 the grooves 9a, 9b of the end cap 4 are provided with metal (for instance copper) conductive ring-shaped contact members 10a, 10b. Said ring-shaped contact members 10a, 10b thus extend co-axially with the lamp axis and are tangentially engaged by the strip shaped contact members 7a, 7b of the socket 1. The end cap 4 further comprises two bores 11a, 11b extending from each groove 9 to an inner axially extending channel, which channel encloses the lamp lead wires 12a, 12b. Said lead wires 12a, 12b are connected in a well-known manner to the electrode inside the discharge vessel 3 and extend through the end wall of the discharge vessel 3. Electrical contact between the contact members 10a, 10b and the corresponding lead wires 12a, 12b is established by contact pins or screws 13a, 13b which extend through a hole in the ring shaped contact members 10a, 10b and the bores 11a, 11b onto the lead wires 12a, 12b.

The lamp 2 can be locked in the socket 1 by a retaining mechanism, which is not shown. This can for instance be a transparent lid, which covers the socket 1. Alternatively the contact members 7a, 7b can have a bent shape such that they resiliently clamp the contact members 10a, 10b of the lamp 2.

FIG. 5 shows an additional optional feature of the lamp, wherein a heating/cooling element 14 is inserted in the end cap 4, which heating/cooling element 14 comprises a tubular wall extending co-axially around the stem 14 of the discharge vessel, said stem 15 comprising an mercury amalgam 16 in a well-known manner. Although not shown in schematic FIG. 5, lead trough wires 12a, 12b extend along the stem 14 on the outside thereof. The heating/cooling element 14 can be heated or cooled whenever necessary in order to raise or lower the mercury pressure inside the discharge vessel and stabilize the lamp properties in that manner. Thereto the ballast, which drives the lamp, is provided with a control circuit, the construction of which will be apparent for the skilled man.

1. A gas discharge lamp (2) comprising a tubular discharge vessel (3) having two end portions, wherein in each end portion an electrode is arranged for generating and maintaining a discharge in the discharge vessel, said lamp (2) having two short substantially tubular end caps (4) coaxially extending from both ends of the discharge vessel (3), wherein each electrode is connected with at least two external metal contact members (10a, 10b) arranged on one of said end caps (4) for connecting the lamp (2) with a power supply, each of said contact members (10a, 10b) comprising an at least partially substantially circular contact surface, characterized in that the at least partially substantially circular contact surfaces are arranged coaxially with said substantially tubular end cap (4) and are mutually axially spaced apart.

2. The gas discharge lamp according to claim 1, wherein the outer diameters of the two substantially circular contact surfaces are smaller than the outer diameter of the end cap (4).

3. The gas discharge lamp according to claim 1, wherein the substantially circular contact surfaces of the contact members (10a, 10b) are located in at least one substantially ring shaped recess (9a, 9b) in the substantially tubular surface of the end cap (4).

4. The gas discharge lamp according to claim 1, wherein each of the substantially circular contact surfaces of the contact members (10a, 10b) is located in a separate substantially ring shaped recess (9a, 9b) in the substantially tubular surface of the end cap (4).

5. The gas discharge lamp according to claim 1, wherein the outer diameters of the substantially circular contact surfaces are substantially equal.

6. The gas discharge lamp according to claim 1, wherein the outer diameter of the end cap (4) is approximately equal to the outer diameter of the discharge vessel (3).

7. The gas discharge lamp according to claim 1, wherein the wall of the discharge vessel (3) comprises at least one coating for changing the light transmitting properties of the wall, said coating extending along substantially the entire length and covering only a part of the circumference of the discharge vessel (3).

8. The gas discharge lamp according to claim 1, wherein each end portion comprises at least two electrodes and at least three contact members (10a, 10b) with substantially circular contact surfaces.

9. Socket (1) for holding and feeding a gas discharge lamp (2) according to claim 1, comprising a housing (5) and two sets of at least two metal socket contact members (7a, 7b) each for contacting the lamp contact members (10a, 10b), said socket contact members (7a, 7b) comprising at least one strip shaped contact surface extending tangential to the substantially circular lamp contact surface of the corresponding lamp contact member (10a, 10b) in the mounted condition.

10. Socket according claim 9, wherein each socket contact member (7a, 7b) comprises two substantially parallel strip shaped contact surfaces which are spaced apart at a distance corresponding to the outer diameter of the substantially ring shaped lamp contact surfaces in the mounted condition.
